(19) United States
(12) Patent Application Publication
(10) Pub. No.: US 2022/0207743 A1
(43) Pub. Date: Jun. 30, 2022

(54) SYSTEM AND METHOD FOR TWO DIMENSIONAL ACOUSTIC IMAGE COMPOUNDING VIA DEEP LEARNING

(71) Applicant: KONINKLIJKE PHILIPS N.V., EINDHOVEN (NL)

(72) Inventors: GRZEGORZ ANDRZEJ TOPOREK, CAMBRIDGE, MA (US); JOCHEN KRUECKER, ANDOVER, MA (US)

(21) Appl. No.: 17/606,176

(22) PCT Filed: Apr. 22, 2020
(86) PCT No.: PCT/EP2020/061111

§ 371 Date: Oct. 25, 2021

Related U.S. Application Data
(60) Provisional application No. 62/838,379, filed on Apr. 25, 2019.

(51) Int. Cl. G06T 7/11; G06T 7/73

(52) U.S. Cl. CPC G06T 7/11; G06T 7/73; G06T 2207/20081; G06T 2207/20084; G06T 2207/10132

(57) ABSTRACT

A system (200) and method (1000): employ an acoustic probe (220) to acquire a series of two dimensional (2D) acoustic images of a region of interest (ROI) (290) in a subject without spatial tracking of the acoustic probe; predict a pose for each of the 2D acoustic images of the ROI in the subject with respect to a standardized three dimensional (3D) coordinate system (500) by applying the 2D acoustic images to a convolutional neural network (600) which has been trained using a plurality of previously-obtained 2D acoustic images of corresponding ROIs in a plurality of other subjects which were obtained with spatial tracking; and use the predicted pose for each of the 2D acoustic images of the ROI in the subject with respect to the standardized 3D coordinate system to produce a 3D acoustic image (820) of the ROI from the series of 2D acoustic images of the ROI.

### TECHNICAL FIELD

This invention pertains to acoustic (e.g., ultrasound) imaging, and in particular a system, device and method which may generate a three dimensional acoustic image by compounding a series of two dimensional acoustic images via deep learning.

### BACKGROUND AND SUMMARY

Acoustic (e.g., ultrasound) imaging systems are increasingly being employed in a variety of applications and contexts.

Acoustic imaging is inherently based on hand-held acoustic probe motion and positioning, thus lacking the absolute three dimensional (3D) reference frame and anatomical context of other modalities such as computed tomography (CT) and magnetic resonance imaging (MRI). This makes interpreting the acoustic images (which are typically two dimensional (2D)) in three dimensions challenging. In addition, it is often desirable to have 3D views of structures, but 3D acoustic imaging is relatively expensive and less commonly used.

In order to obtain 3D volumetric acoustic images from a series of 2D acoustic images, one needs to know the relative position and orientation (herein together referred as the “pose”) of all of the 2D acoustic images with respect to each other. In the past, when these 2D acoustic images are obtained from a hand-held 2D acoustic probe, spatial tracking of the probe has been required in order to obtain the relative pose for each 2D acoustic image and “reconstruct” a 3D volumetric acoustic image from the sequence of individual, spatially localized, 2D images.

Until now, this has required additional hardware, such as optical or electromagnetic (EM) tracking systems, and involved additional work steps and time to set up and calibrate the system, adding expense and time to the imaging procedure. In order to obtain a registration between acoustic and another imaging modality, for example, it is required to identify common fiducials, common anatomical landmarks, or perform a registration based on image contents, all of which can be challenging, time consuming, and prone to error. A tracking system also typically puts constraints on how the acoustic probe can be used, e.g. by limiting the range of motion. Fully “internal” tracking systems, e.g. based on inertial sensors, exist but are limited in accuracy, suffer from long-term drift, and do not provide an absolute coordinate reference needed to relate or register the acoustic image information to image data obtained via other modalities.

These barriers have significantly impeded the adoption of 3D acoustic imaging in clinical settings.

Accordingly, it would be desirable to provide a system and a method which can address these challenges. In particular, it would be desirable to provide a system and method which can compound a series of 2D acoustic images which were acquired without spatial tracking, to produce a 3D acoustic image.

In one aspect of this disclosure, a system comprises: an acoustic probe and an acoustic imaging instrument. The acoustic probe has an array of acoustic transducer elements, and the acoustic probe is not associated with any tracking device. The acoustic probe is configured to transmit one or more acoustic signals to a region of interest (ROI) in a subject and is further configured to receive acoustic echoes from the region of interest. The acoustic imaging instrument is connected to the acoustic probe, and comprises an instrument communication interface and a processing system. The instrument communication interface is configured to provide transmit signals to at least some of the acoustic transducer elements to cause the array of acoustic transducer elements to transmit the one or more acoustic signals to the ROI in the subject, and further configured to receive one or more image signals from the acoustic probe produced from the acoustic echoes from the region of interest. The processing system includes memory, and is configured to: acquire a series of two dimensional acoustic images of the ROI in the subject from the image signals received from the acoustic probe without spatial tracking of the acoustic probe; predict a pose for each of the two dimensional acoustic images of the ROI in the subject based on a plurality of previously-obtained two dimensional acoustic images of corresponding ROIs in a plurality of other subjects which were obtained with spatial tracking. In certain embodiments, thee two dimensional acoustic images are applied to a convolutional neural network (CNN) which has been trained using a plurality of previously-obtained two dimensional acoustic images of corresponding ROIs in a plurality of other subjects which were obtained with spatial tracking. The predicted pose may then be used for each of the two dimensional acoustic images of the ROI in the subject with respect to the standardized three dimensional coordinate system to produce a three dimensional acoustic image of the ROI in the subject from the series of two dimensional acoustic images of the ROI of the subject.

In some embodiments, the system further comprises a display device, and the system is configured to display on the display device a representation of the three dimensional acoustic image of the ROI in the subject.

In some embodiments, the system is configured to use the predicted poses to display on a display device a plurality of the two dimensional acoustic images relative to each other in the ROI.

In some embodiments, the system is configured to: access a three dimensional reference image obtained using a different imaging modality than acoustic imaging; register the three dimensional acoustic image to the three dimensional reference image; and display on a display device the three dimensional acoustic image and the three dimensional reference image, registered with each other.

In some versions of these embodiments, the system is configured to superimpose the three dimensional acoustic image and the three dimensional reference image with each other on the display device.

In some embodiments, the ROI in the subject includes a reference structure, and the system is configured to: segment the reference structure in the three dimensional acoustic image of the ROI of the subject; register the segmented reference structure organ to a generic statistical model of the reference structure; and display on the display device at least one of the two dimensional images of the ROI in the subject relative to the generic statistical model of the reference structure.

In some embodiments, the system is configured to: generate one or more cut-plane views from the three dimensional acoustic image with is not coplanar with any of the two dimensional images of the ROI in the subject, and display on a display device the one or more cut-plane views.

In another aspect of this disclosure, a method comprises: employing an acoustic probe to acquire a series of two dimensional acoustic images of a region of interest (ROI) in a subject without spatial tracking of the acoustic probe; predicting (1030) a pose for each of the two dimensional acoustic images of the ROI in the subject with respect to a standardized three dimensional coordinate system (500) based on a plurality of previously-obtained two dimensional acoustic images of corresponding ROIs in a plurality of other subjects which were obtained with spatial tracking; and using the predicted pose for each of the two dimensional acoustic images of the ROI in the subject with respect to the standardized three dimensional coordinate system to produce a three dimensional acoustic image of the ROI in the subject from the series of two dimensional acoustic images of the ROI of the subject.

In some embodiments, the pose may be predicted by applying two dimensional acoustic images to a convolutional neural network which has been trained using a plurality of previously-obtained two dimensional acoustic images of corresponding ROIs in a plurality of other subjects which were obtained with spatial tracking; the convolutional neural network predicting a pose for each of the two dimensional acoustic images of the ROI in the subject with respect to a standardized three dimensional coordinate system.

In some embodiments, the method further comprises displaying on the display device a representation of the three dimensional acoustic image of the ROI in the subject.

In some embodiments, the method further comprises using the predicted poses to display on the display device a plurality of the two dimensional acoustic images relative to each other in the ROI.

In some embodiments, the method further comprises: accessing a three dimensional reference image obtained using a different imaging modality than acoustic imaging; registering the three dimensional acoustic image to the three dimensional reference image; and displaying on the display device the three dimensional acoustic image and the three dimensional reference image, registered with each other.

In some embodiments, the method further comprises superimposing the three dimensional acoustic image and the three dimensional reference image with each other on the display device.

In some embodiments, the ROI in the subject includes a reference structure, and the method further comprises: segmenting the reference structure in the three dimensional acoustic image of the ROI of the subject; registering the segmented reference structure organ to a generic statistical model of the reference structure; and displaying on a display device at least one of the two dimensional images of the ROI in the subject relative to the generic statistical model of the reference structure.

In some embodiments, the method further comprises: generating one or more cut-plane views from the three dimensional acoustic image with is not coplanar with any of the two dimensional images of the ROI in the subject, and displaying on the display device the one or more cut-plane views.

In yet another aspect of the disclosure, a method comprises: obtaining a plurality of series of spatially tracked two dimensional acoustic images of a region of interest (ROI) in a corresponding plurality of subjects; for each series of spatially tracked two dimensional acoustic images, constructing a three dimensional volumetric acoustic image of the ROI in the corresponding subject; segmenting a reference structure within each of the three dimensional volumetric acoustic images of the ROI; defining a corresponding acoustic image three dimensional coordinate system for each of the three dimensional volumetric acoustic images, based on the segmentation; defining a standardized three dimensional coordinate system for the ROI; determining for each of the spatially tracked two dimensional acoustic images of the ROI in the plurality of series its actual pose in the standardized three dimensional coordinate system, using: a pose of the spatially tracked two dimensional acoustic image in the acoustic image three dimensional coordinate system corresponding to the spatially tracked two dimensional acoustic image, and a coordinate system transformation from the corresponding acoustic image three dimensional coordinate system to the standardized three dimensional coordinate system; providing, to a convolutional neural network, the spatially tracked two dimensional acoustic images of the ROI from the plurality of series, wherein the convolutional neural network generates a predicted pose in the standardized three dimensional coordinate system for each of the provided spatially tracked two dimensional acoustic images; and performing an optimization process on the convolutional neural network to minimize differences between the predicted poses and the actual poses for all of the provided spatially tracked two dimensional acoustic images.

In some embodiments, the reference structure is an organ, and segmenting the reference structure in each of the three dimensional volumetric acoustic images of the ROI comprises segmenting the organ in the three dimensional volumetric acoustic image.

In some embodiments, defining the standardized three dimensional coordinate system for the ROI comprises: defining an origin for the standardized three dimensional coordinate system at a centroid of the segmented organ; and defining three mutually orthogonal axes of the standardized three dimensional coordinate system to be aligned with axial, coronal, and sagittal planes of the organ.

In some embodiments, defining the standardized three dimensional coordinate system for the ROI comprises selecting an origin and three mutually orthogonal axes for the standardized three dimensional coordinate system based on a priori knowledge about the reference structure.

In some embodiments, the provided spatially tracked two dimensional acoustic images are randomly selected from the plurality of series of spatially tracked two dimensional acoustic images of the ROI in the corresponding plurality of subjects.

In some embodiments, obtaining the series of spatially tracked two dimensional acoustic images of the ROI in the subject comprises receiving one or more imaging signals from an acoustic probe in conjunction with receiving an inertial measurement signal from an inertial measurement unit which spatially tracks movement of the acoustic probe while it provides the one or more imaging signals

### BRIEF DESCRIPTION OF THE DRAWINGS

FIG. 1 illustrates generation of a three dimensional (3D) volumetric acoustic image from a series of two dimensional (2D) acoustic images.

FIG. 2 illustrates an example embodiment of an acoustic imaging system.

FIG. 3 illustrates an example embodiment of a processing system which may be included in an acoustic imaging apparatus and/or an apparatus for processing two dimensional (2D) acoustic images obtained via an acoustic imaging apparatus to produce a three dimensional volumetric acoustic image.

FIG. 4 illustrates an example embodiment of an acoustic probe.

FIG. 5 illustrates an example of a definition of standardized organ-centered coordinate system.

FIG. 6 depicts graphically an example of a deep convolutional neural network (CNN).

FIG. 7 depicts a process of optimizing the performance of a CNN with a training set of data.

FIG. 8 depicts an example of localization of a sequence of un-tracked 2D acoustic images based on the predictions of a trained convolutional neural network.

FIG. 9 illustrates a flowchart of an example embodiment of a method of training a convolutional neural network to provide accurate estimates of the poses of two dimensional acoustic images in a three dimensional standardized coordinate system.

FIG. 10 illustrates a flowchart of an example embodiment of a method of processing a sequence of 2D acoustic images of a region of interest (ROI) in a subject, obtained without spatial tracking, to produce a 3D volumetric acoustic image of the ROI.

### DETAILED DESCRIPTION

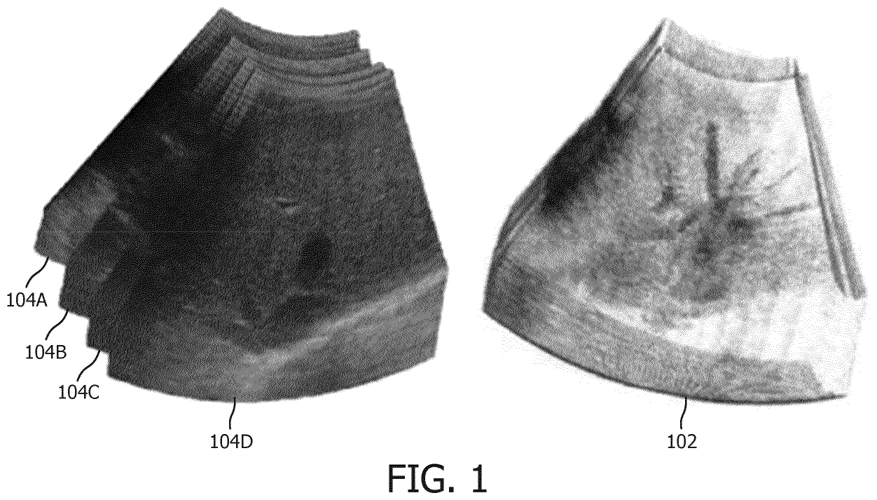

FIG. 1 illustrates generation of a three dimensional (3D) volumetric acoustic image 102 by compounding a series of two dimensional (2D) acoustic images e.g. 104A, 104B, 104C, and 104D. In some embodiments more than four 2D acoustic images may be used to generate the 3D volumetric acoustic image 102. As discussed above, it would be desirable to provide a system and method which can compound a series of 2D acoustic images which were acquired without spatial tracking, to produce a 3D acoustic image.

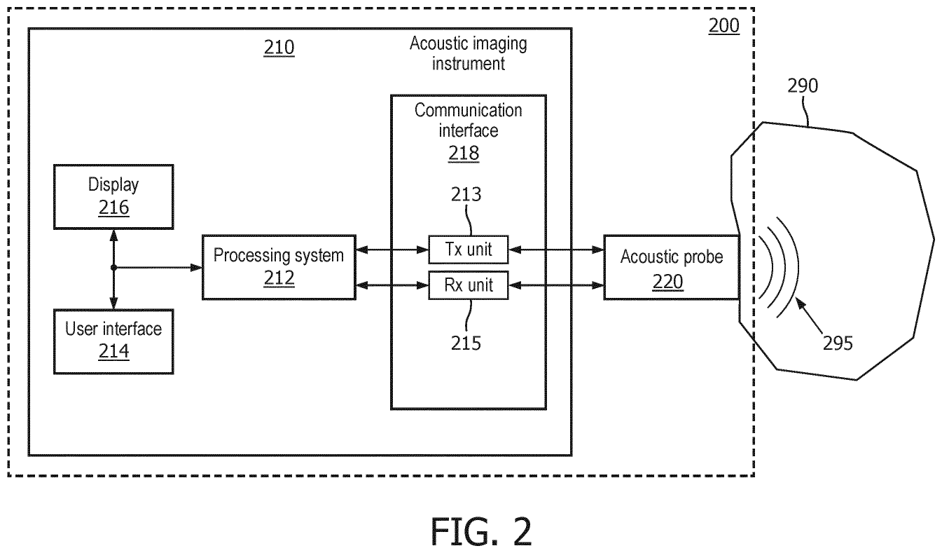

FIG. 2 illustrates an example embodiment of an acoustic imaging system 200 which includes an acoustic imaging instrument 210 and an acoustic probe 220. Acoustic imaging instrument 210 includes a processing system 212, a user interface 214, a display device 216 and an instrument communication interface 218. In some embodiments instrument communication interface 218 includes a transmit unit 213 and a receiver unit 215. Transmit unit 213 may generate one or more electrical transmit signals under control of processor 212 and supply the electrical transmit signals to acoustic probe 220. Transmit unit 213 may include various circuits as are known in the art, such as a clock generator circuit, a delay circuit and a pulse generator circuit, for example. The clock generator circuit may be a circuit for generating a clock signal for setting the transmission timing and the transmission frequency of a drive signal. The delay circuit may be a circuit for setting delay times in transmission timings of drive signals for individual paths corresponding to the transducer elements of acoustic probe 220 and may delay the transmission of the drive signals for the set delay times to concentrate the acoustic beams to produce acoustic probe signal 295 having a desired profile for insonifying a desired acoustic image plane. The pulse generator circuit may be a circuit for generating a pulse signal as a drive signal in a predetermined cycle. Acoustic probe signal 295 may be emitted into area of interest 290. Area of interest 290 may be portion of a creature, e.g. a human being or an animal. The creature may be alive or dead.

Acoustic imaging system 200 may be employed in a method of fusing acoustic images, obtained in the absence of any tracking devices or systems. In some embodiments acoustic imaging system 200 may utilize images obtained via other imaging modalities, such as magnetic resonance imaging, MRI, computed tomography (CT), cone beam computed tomography (CBCT), etc. Elements of acoustic imaging system 200 may be constructed utilizing hardware i.e. circuitry, software or a combination of hardware and software.

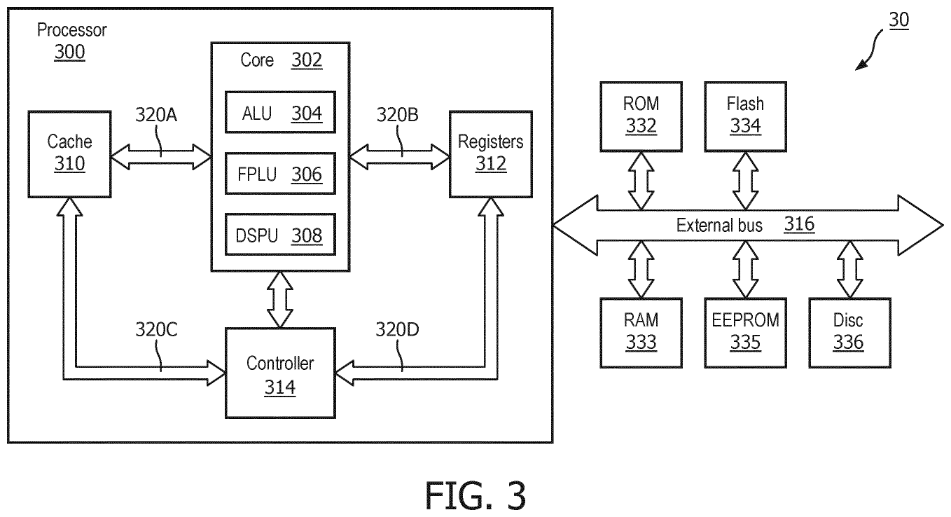

FIG. 3 is a block diagram illustrating an example processing system 30 according to embodiments of the disclosure. Processing system 30 may be used to implement one or more processing systems or controllers described herein, for example, processing system 212 shown in FIG. 2 or dataset processing controller (DPC) described below. FIG. 3 illustrates an example embodiment of a processing system 30 which may be included in an acoustic imaging system (e.g., acoustic imaging system 200) and/or an apparatus (e.g., acoustic imaging instrument 210) for registering and fusing acoustic images of a region of interest (ROI) 290 of a subject obtained in the absence of any tracking devices, with images of the ROI in the subject which were obtained via other imaging modalities such as magnetic resonance imaging (MRI).

Processing system 30 includes a processor 300 connected to one or more external memory devices by an external bus 316.

Processor 300 may be any suitable processor type including, but not limited to, a microprocessor, a microcontroller, a digital signal processor (DSP), a field programmable array (FPGA) where the FPGA has been programmed to form a processor, a graphical processing unit (GPU), an application specific circuit (ASIC) where the ASIC has been designed to form a processor, or a combination thereof.

Processor 300 may include one or more cores 302. The core 302 may include one or more arithmetic logic units (ALU) 304. In some embodiments, the core 302 may include a floating point logic unit (FPLU) 306 and/or a digital signal processing unit (DSPU) 308 in addition to or instead of the ALU 304.

Processor 300 may include one or more registers 312 communicatively coupled to the core 302. The registers 312 may be implemented using dedicated logic gate circuits (e.g., flip-flops) and/or any memory technology. In some embodiments the registers 312 may be implemented using static memory. The register may provide data, instructions and addresses to the core 302.

In some embodiments, processor 300 may include one or more levels of cache memory 310 communicatively coupled to the core 302. The cache memory 310 may provide computer-readable instructions to the core 302 for execution. The cache memory 310 may provide data for processing by the core 302. In some embodiments, the computer-readable instructions may have been provided to the cache memory 310 by a local memory, for example, local memory attached to the external bus 316. The cache memory 310 may be implemented with any suitable cache memory type, for example, metal-oxide semiconductor (MOS) memory such as static random access memory (SRAM), dynamic random access memory (DRAM), and/or any other suitable memory technology.

Processor 300 may include a controller 314, which may control input to the processor 300 from other processors and/or components included in a system (e.g., user interface 214 shown in FIG. 2) and/or outputs from the processor 300 to other processors and/or components included in the system (e.g., instrument communication interface 218 shown in FIG. 2). Controller 314 may control the data paths in the ALU 304, FPLU 306 and/or DSPU 308. Controller 314 may be implemented as one or more state machines, data paths and/or dedicated control logic. The gates of controller 314 may be implemented as standalone gates, FPGA, ASIC or any other suitable technology.

Registers 312 and the cache 310 may communicate with controller 314 and core 302 via internal connections 320A, 320B, 320C and 320D. Internal connections may be implemented as a bus, multiplexor, crossbar switch, and/or any other suitable connection technology.

Inputs and outputs for processor 300 may be provided via a bus 316, which may include one or more conductive lines. The bus 316 may be communicatively coupled to one or more components of processor 300, for example the controller 314, cache 310, and/or register 312.

Bus 316 may be coupled to one or more external memories. The external memories may include Read Only Memory (ROM) 332. ROM 332 may be a masked ROM, Electronically Programmable Read Only Memory (EPROM) or any other suitable technology. The external memory may include Random Access Memory (RAM) 233. RAM 333 may be a static RAM, battery backed up static RAM, Dynamic RAM (DRAM) or any other suitable technology. The external memory may include Electrically Erasable Programmable Read Only Memory (EEPROM) 335. The external memory may include Flash memory 334. The External memory may include a magnetic storage device such as disc 336. In some embodiments, the external memories may be included in a system, such as acoustic imaging system 200 shown in FIG. 2.

It should be understood that in various embodiments, acoustic imaging system 200 may be configured differently than described below with respect to FIG. 2. In particular, in different embodiments, one or more functions described as being performed by elements of acoustic imaging instrument 210 may instead be performed in acoustic probe 220 depending, for example, on the level of signal processing capabilities which might be present in acoustic probe 220.

In various embodiments, processor 212 may include various combinations of a microprocessor (and associated memory), a digital signal processor, an application specific integrated circuit (ASIC), a field programmable gate array (FPGA), digital circuits and/or analog circuits. Memory (e.g., nonvolatile memory), associated with processor 212, may store therein computer-readable instructions which cause a microprocessor of processor 212 to execute an algorithm to control acoustic imaging system 200 to perform one or more operations or methods which are described in greater detail below. In some embodiments, a microprocessor may execute an operating system. In some embodiments, a microprocessor may execute instructions which present a user of acoustic imaging system 200 with a graphical user interface (GUI) via user interface 214 and display device 216.

In various embodiments, user interface 214 may include any combination of a keyboard, keypad, mouse, trackball, stylus /touch pen, joystick, microphone, speaker, touchscreen, one or more switches, one or more knobs, one or more buttons, one or more lights, etc. In some embodiments, a microprocessor of processor 212 may execute a software algorithm which provides voice recognition of a user's commands via a microphone of user interface 214.

Display device 216 may comprise a display screen of any convenient technology (e.g., liquid crystal display). In some embodiments the display screen may be a touchscreen device, also forming part of user interface 214.

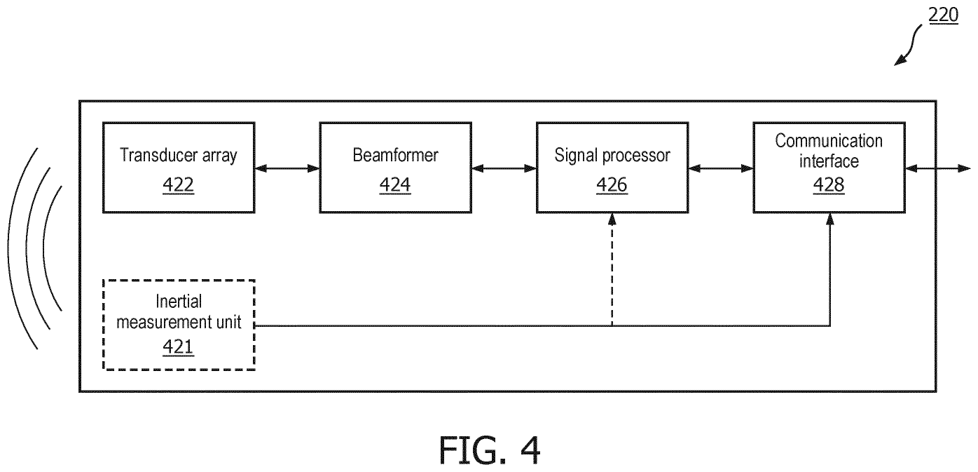

Beneficially, as described below with respect to FIG. 4, acoustic probe 220 may include an array of acoustic transducer elements 422, for example a two dimensional (2D) array or a linear or one dimensional (1D) array. In some embodiments, transducer elements 422 may comprise piezoelectric elements. In operation, at least some of acoustic transducer elements 422 receive electrical transmit signals from transmit unit 213 of acoustic imaging instrument 210 and convert the electrical transmit signals to acoustic beams to cause the array of acoustic transducer elements 422 to transmit an acoustic probe signal 295 to area of interest 290. Acoustic probe 220 may insonify an acoustic image plane in area of interest 290 and a relatively small region on either side of the acoustic image plane (i.e., it expands to a shallow field of view).

Also, at least some of acoustic transducer elements 422 of acoustic probe 220 receive acoustic echoes from area of interest 290 in response to acoustic probe signal 295 and convert the received acoustic echoes to one or more electrical signals representing an acoustic image of area of interest 290, in particular a two dimensional (2D) acoustic image. These electrical signals may be processed further by acoustic probe 220 and communicated by a probe communication interface 428 of acoustic probe 220 (see FIG. 2) to receive unit 215 as one or more acoustic image signals.

Receive unit 215 is configured to receive the one or more acoustic image signals from acoustic probe 220 via probe communication interface 428 and to process the acoustic image signal(s) to produce acoustic image data from which 2D acoustic images may be produced. In some embodiments, receive unit 215 may include various circuits as are known in the art, such as one or more amplifiers, one or more A/D conversion circuits, and a phasing addition circuit, for example. The amplifiers may be circuits for amplifying the acoustic image signals at amplification factors for the individual paths corresponding to the transducer elements 422. The A/D conversion circuits may be circuits for performing analog/digital conversion (A/D conversion) on the amplified acoustic image signals. The phasing addition circuit is a circuit for adjusting time phases of the amplified acoustic image signals to which A/D conversion is performed by applying the delay times to the individual paths respectively corresponding to the transducer elements 422 and generating acoustic data by adding the adjusted received signals (phase addition). The acoustic data may be stored in memory associated with acoustic imaging instrument 200.

Processor 212 may reconstruct acoustic data received from receiver unit 215 into a 2D acoustic image corresponding to an acoustic image plane which intercepts area of interest 290, and subsequently causes display device 216 to display this 2D acoustic image.

The reconstructed 2D acoustic image may for example be an ultrasound Brightness-mode “B-mode” image, otherwise known as a “2D mode” image, a “C-mode” image or a Doppler mode image, or indeed any acoustic image.

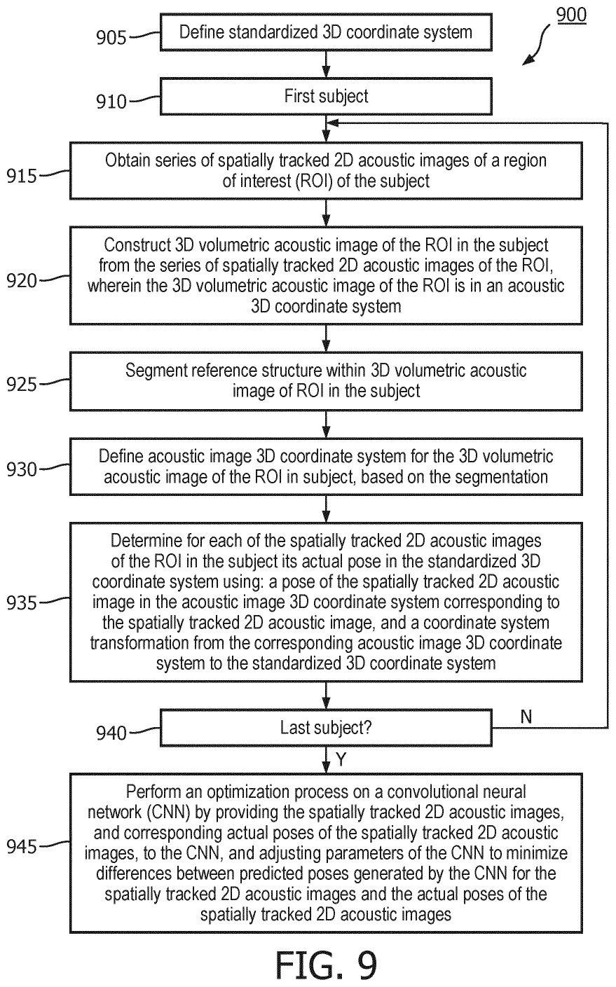

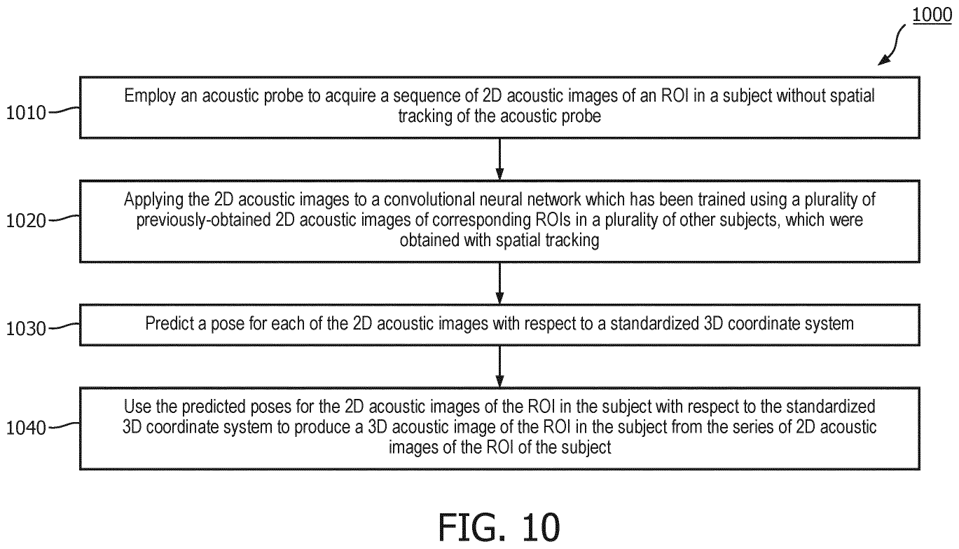

In various embodiments, processing system 212 may include a processor (e.g., processor 300) which may execute software in one or more modules for performing one or more algorithms or methods as described below with respect to FIGS. 9 and 10.

Of course it is understood that acoustic imaging instrument 210 may include a number of other elements not shown in FIG. 2, for example a power supply system for receiving power from AC Mains, a communication subsystem for communicating with other eternal devices and systems (e.g., via a wireless, Ethernet and/or Internet connection), etc.

In some embodiments, acoustic imaging instrument 210 also receives an inertial measurement signal from an inertial measurement unit (IMU) included in or associated with acoustic probe 220. The inertial measurement signal may indicate an orientation or pose of acoustic probe 220. The inertial measurement unit may include a hardware circuit, a hardware sensor or Microelectromechanical systems (MEMS) device. The inertial measurement circuity may include a processor, such as processor 300, running software in conjunction with a hardware sensor or MEMS device.

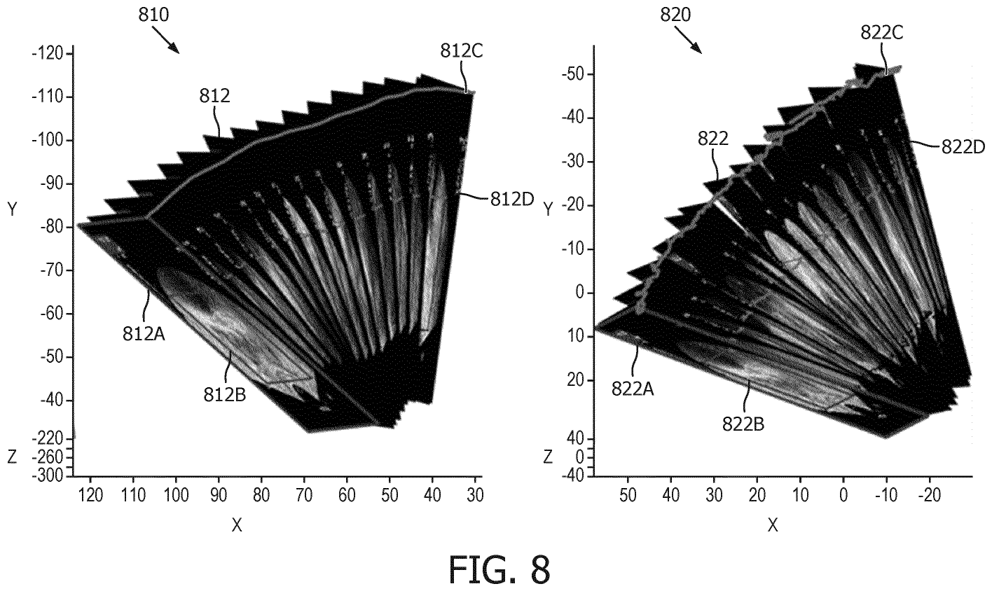

In other embodiments, acoustic imaging instrument does not receive any inertial measurement signal, but may determine a relative orientation or pose of acoustic probe 220 as described in greater detail below, for example with respect to FIGS. 8 and 10.

FIG. 4 illustrates an example embodiment of acoustic probe 220.

Acoustic probe 220 includes an array of acoustic transducer elements 422, a beamformer 424, a signal processor 426, and a probe communication interface 428.

In some embodiments, particularly in the case of an embodiment of acoustic probe 220 and acoustic imaging system 200 which is used in a training phase of a process or method as described in greater detail below for example with respect to FIG. 9, acoustic probe 220 may include or be associated with an inertial measurement unit 421 or another tracking device for obtaining relative orientation and position information for acoustic probe 220, and the 2D acoustic images obtained by acoustic imaging system 200 via acoustic probe 220 include or have associated therewith pose or tracking information for acoustic probe 220 while the 2D acoustic images are being acquired. In some embodiments, inertial measurement unit 421may be a separate component not included within acoustic probe 220, but instead connected to or otherwise associated therewith, such as being affixed to or mounted on acoustic probe 220. Inertial measurement units per se are known. Inertial measurement unit 421is configured to provide an inertial measurement signal to acoustic imaging instrument 210 which indicates a current orientation or pose of acoustic probe 220 so that a 3D volume and 3D acoustic image may be constructed from a plurality of 2D acoustic images obtained with different poses of acoustic probe 220.

In other embodiments, particularly in the case of an embodiment of acoustic probe 220 and acoustic imaging system 200 which is used in an application phase of a process or method as described in greater detail below for example with respect to FIG. 10, acoustic probe 220 does not include any inertial measurement unit 121, and the 2D acoustic images obtained by acoustic imaging system 200 via acoustic probe 220 do not include or have associated therewith any pose or tracking information for acoustic probe 220 while the 2D acoustic images are being acquired.

Disclosed in greater detail below are arrangements based on acoustic imaging systems such as acoustic imaging system 200 which may be employed in a method of processing a series of 2D acoustic images, obtained in the absence of any tracking devices or systems, and generating therefrom a 3D acoustic image.

In some embodiments, these arrangements include what is referred to herein as a “training framework” and what is referred to herein as an “application framework.”

The training framework may execute a training process, as described in greater detail below, for example with respect to FIG. 9, using an embodiment of acoustic imaging system 200 which includes and utilizes IMU 421and/or another tracking device or system (e.g., electromagnetic or optical) which allows acoustic imaging system 200 to capture or acquire sets of spatially tracked two dimensional (2D) acoustic images.

The application framework may execute an application process, as described in greater detail below, for example with respect to FIG. 10, using an embodiment of acoustic imaging system 200 which does not include or utilize IMU 421or another tracking device or system.

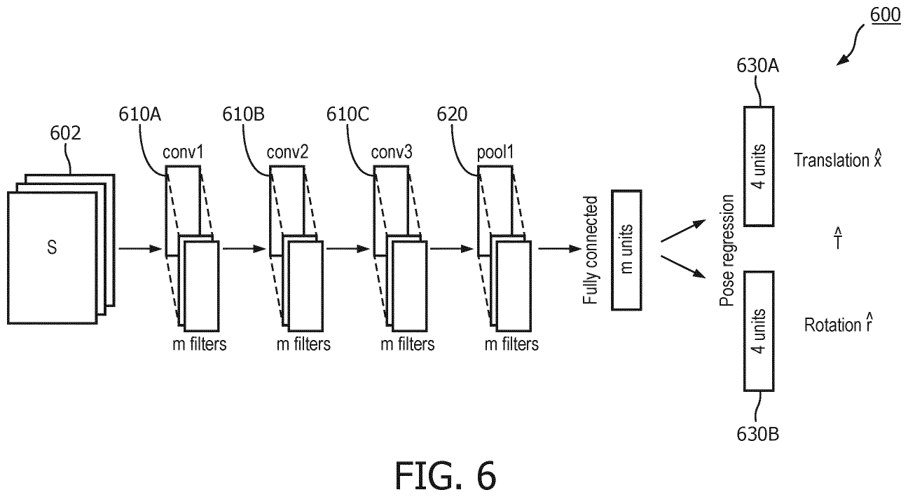

In some embodiments, the training framework may be established in a factory or laboratory setting, and training data obtained thereby may be stored on a data storage device, such as any of the external memories discussed above with respect to FIG. 3. Optimized parameters for a convolutional neural network 600 of acoustic imaging system 200 (shown in FIG. 6), as discussed in greater detail below, may also be stored on a data storage device, such as any of the external memories discussed above with respect to FIG. 3.

In some embodiments, the application framework may be defined in a clinical setting wherein an embodiment of acoustic imaging system 200 which does not include or utilize IMU 421or other tracking device or system is used by a physician or clinician to obtain acoustic images of a subject or patient. In various embodiments, the data storage device which stores the optimized parameters for the convolutional neural network 600 may be included in or connected, either directly or via a computer network, including in some embodiments the Internet, to an embodiment of acoustic imaging system 200 which executes the application framework. In some embodiments, optimized parameters for the convolutional neural network 600 may be “hardwired” into the convolutional neural network 600 of acoustic imaging system 200.

Summaries of embodiments of the training framework and the application framework will now be provided, followed by more detailed descriptions thereof.

In some embodiments, the following operations may be performed within the training framework.
Acquisition of spatially tracked acoustic “sweeps” across a region of interest (i.e. sets of spatially tracked two dimensional (2D) acoustic images in a region of interest (ROI) in a subject population. Beneficially, the ROI includes a reference structure such as an organ, bone, joint, etc. Acquisitions are taken of organs (or other reference structures) of different size, shape, and location, as well as acquisitions having diverse image quality, acquisition parameters, and probe orientation. Spatial tracing of the probe can be achieved for instance via electromagnetic or optical tracking of the acoustic probe or via the use of IMU 421. Beneficially, the number of images (N_{image})≥20 and the number of subjects (N_{subject})≥20.
Reconstruction of a volumetric three dimensional (3D) acoustic image from each sweep of the tracked 2D acoustic images using methods known in the art, such as those disclosed by Qing-Hua Huang, et al., “Volume reconstruction of freehand three-dimensional ultrasound using median filters,” ULTRASONICS 48, pp. 182-192, 2008) and incorporated by reference herein. This reconstruction also yields the pose of each constituent 2D acoustic image, Sᵢ, within the 3D acoustic reconstruction coordinate system, i.e., the transformations T_{2DUS_to_3DUS} for each 2D acoustic frame, i=1 . . . N_{image}, which are computed based on the individual tracked poses of each 2D acoustic image Sᵢ in tracking coordinates, and the known pose of the 3D acoustic reconstruction in tracking coordinates.
Segmenting the region of interest (ROI) (or reference structure, such as an organ) in the three dimensional (3D) acoustic images. Structures such as organs can be segmented using methods known in the art, such as thresholding, model-based segmentation, manual segmentation, or region growing segmentation.
Defining a standardized 3D coordinate system based on the segmentations in the 3D acoustic images, e.g. defined by an origin of the coordinate system at the centroid of the segmentation, and rotation of the coordinate system to align the XY, XZ, and YZ planes with the axial, sagittal and coronal planes of the organ, or alternatively axial, sagittal, and coronal planes defined by a priori knowledge about the size, shape, orientation, etc. of a reference structure (e.g., an organ, bone, joint, etc.) in the ROI may be used in defining the standardized 3D coordinate system.

Although in the example above, it should be understood that the standardized 3D coordinate system could also have an origin at a vessel bifurcation and an axis oriented along one or two vessels; it could also have an origin at the distinguishable anatomical landmark, such as bony structure, etc. Everything that one can manually or automatically define in the 3D acoustic image of the ROI and relate to the 3D acoustic image can be employed to define the standardized 3D coordinate system.

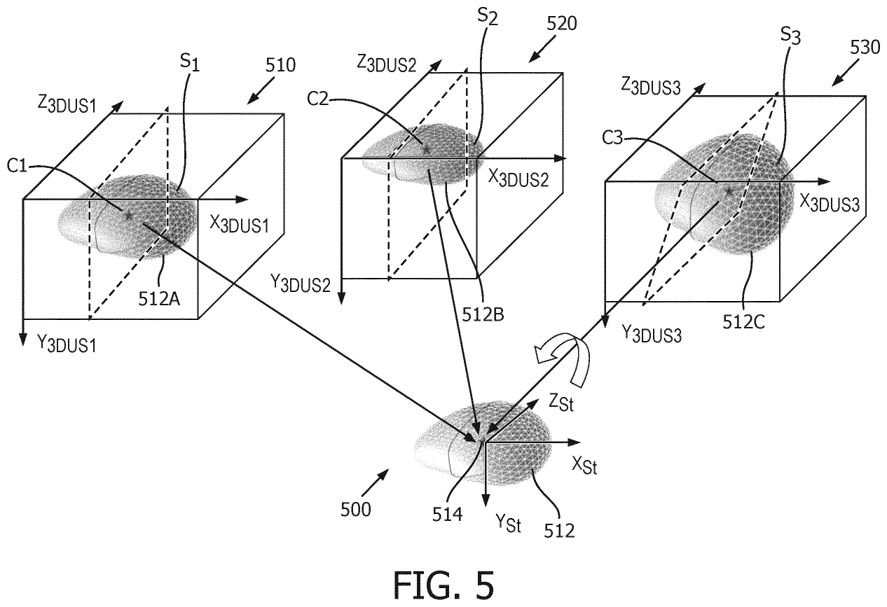

FIG. 5 illustrates an example of a definition of standardized 3D coordinate system 500. Here, a 3D image of an organ 512 is obtained in several (e.g., three) patients as 512A, 512B, 512C. Organ 512 is then segmented for each patient, providing the segmentations (Sₗ to Sₙ) in the individual acoustic image 3D coordinate systems (3DUSI to 3DUSₙ) for the 3D acoustic images. A standard anatomical plane, such as the mid-sagittal plane through the organ segmentation, is identified (dashed line). Note that the center of the segmentation (Cₙ) and the orientation of the standard plane may differ from one acquisition to another. For each acquisition, an organ-centered standardized 3D coordinate system 510, 520, 530 is defined with origin 514 at the center of the segmentation, and the anatomical plane aligned with 2 of the coordinate axes (here: Yₛₜ and Zₛₜ) of the standardized 3D coordinate system 500 for a standardized “organ” 512.
Training a convolutional neural network (CNN) to predict the 2D acoustic frame positions in the standardized 3D coordinates, by providing to the network input/output pairs (each 2D acoustic image Si paired with its pose Ti in standardized 3D coordinates) and performing an optimization of the parameters/weights of the CNN until the predicted poses are optimally predicted compared to the actual poses based on the 2D acoustic image input.

FIG. 6 depicts graphically an example of a deep convolutional neural network 600 which may be employed in the training phase and/or application phase of operation as described herein, and in greater detail with respect to FIGS. 9 and 10 below, for an acoustic imaging system such as acoustic imaging system 200. FIG. 6 depicts an example of a deep convolutional neural network 600 which processes input data sets 602. Convolutional neural network 600 includes a plurality of intermediate layers 610A, 610B, 610C and 610D. Convolutional neural network 600 may have more than four intermediate layers or fewer. Convolutional neural network 600 may have one or more final fully connected or global average pooling layer 620, followed by a plurality of regression layers 630A and 630B for regression of translational and rotational components of a rigid coordinate system transformation. Convolutional neural network 600 may have one regression layer, two layers or more than two layers. In one exemplaryembodiment, the intermediate layers are convolutional layers, including convolution operations, non-linear regularization, batch normalization, and spatial pooling. This rigid transformation might have a vectorial or non-vectorial parametric representation and therefore the number and dimensions of last regression layers may vary. For instance, rotation can be represented as Euler angles, quaternions, matrix, exponential map, and angle-axis, whereas translation can be separated into direction and magnitude.

Convolutional neural network 600 may be trained using a batch-wise approach on the task to regress the rigid transformation given an input 2D ultrasound image.

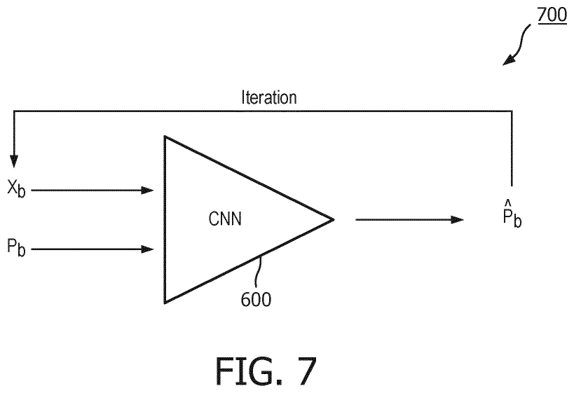

FIG. 7 depicts an example process 700 of optimizing the performance of a CNN with a training set of data using a mini-batch training approach. Here at each iteration batch Xb of data (images) is input to convolutional neural network 600, which output is then compared with a batch Pb of data (poses) to optimize the parameters of the CNN.

During training, the data input to convolutional neural network 600 is a 2D ultrasound image and a ground truth position of that 2D acoustic image with respect to a standardized 3D coordinate system. The input to the training framework is pairs or tuples of (2D acoustic image, ground truth poses). The input to the CNN is the image and the output is a prediction of the pose. The optimizer in the training framework modifies the CNN's parameters so that the prediction for each image approximates the corresponding known ground truth in an optimal way (e.g. minimizing the sum of absolute differences of the pose parameters between prediction and ground truth) In operation after training, convolutional neural network 600 takes a currently produced 2D acoustic image of a subject and predicts the rigid transformation to yield a predicted pose for the 2D acoustic image in the standardized 3D coordinate system.

Accordingly, the training framework automatically generates a training dataset of 2D acoustic images of a region or organ of interest, and corresponding actual poses of those 2D acoustic images in the standardized 3D coordinate system. The training framework then uses the training dataset to train a neural network (e.g., convolutional neural network 600) using the training dataset to optimize the neural network's ability to predict poses for other 2D acoustic images of the region (or e.g., organ) of interest.

In some embodiments, the following operations may be performed within the application framework.
Acquisition of a sweep of 2D acoustic images in a subject in or near a ROI, or reference structure (e.g., organ) within the area covered by at least one of the acoustic sweeps which were made during training.
For each 2D acoustic image, using the trained convolutional neural network, obtained during the training phase, to predict the 2D acoustic frame pose in the standardized 3D coordinate system.
Using the resulting pose of the 2D acoustic images in standardized 3D coordinate system to produce a 3D acoustic image of the ROI in the subject from the series of 2D acoustic images of the ROI of the subject. In some embodiments, the pose of the 2D acoustic images obtains from the trained convolutional neural network may be used to: visualize its spatial pose relative to the reconstructed 3D acoustic image volume, visualize its spatial pose relative to a generic, statistical model of the anatomy that is registered to a segmented organ from the reconstructed 3D acoustic image volume, and/or provide feedback on its pose relative to the standardized 3D coordinate system shown within the reconstructed 3D acoustic image volume.

In some embodiments, the 3D acoustic volume reconstruction can then be used to, e.g., make measurements of an organ in all three dimensions, obtain arbitrary “cut plane” views (aka. multi-planar reconstructions, or MPRs) of an organ, or register the 3D acoustic volume reconstruction with a model of an organ or with another image obtained with a different imaging modality (e.g., computer tomography (CT) or magnetic resonance imaging (MRI).

Various components of systems implementing the training framework and the application framework will now be described in greater detail.

Some embodiments of the training framework utilize a training dataset, a dataset processing controller, and a neural network training controller (NNT). In some embodiments, the DPC and/or the NNT may comprise a processing system such as processing system 30 described above.

The training dataset consists of a collection of spatially tracked 2D acoustic image sweeps over a specific part of the anatomy (e.g., an organ) in a subject population (beneficially a population of at least twenty subjects). Beneficially, the subject population exhibits variations in age, size of the anatomy, pathology, etc. 3D acoustic volumes are reconstructed from 2D acoustic images using methods which are known in the art (e.g., as disclosed Huang, et al., cited above). The acoustic probe (e.g., acoustic probe 220) which is used with an acoustic imaging system (e.g., acoustic imaging system 200) to obtain the spatially tracked 2D acoustic image sweeps can be tracked using one of the position measurement systems known in the art, such as optical tracking devices or systems, EM tracking devices or systems, IMU-based tracking, etc.. Based on the spatial tracking of the acoustic probe while acquiring the 2D acoustic images, the transformation describing the pose of each 2D acoustic image S, relative to the reconstructed 3D acoustic volume, T_{2DUS_to_3DUS}, is known.

The DPC is configured to: load a single case from the training dataset, segment the area of interest or organ of interest from the 3D acoustic images ; based on the segmented mask create a mesh using, e.g., a marching cubes algorithm that is known in the art; and based on the mesh define a standardized 3D coordinate system (see FIG. 5, discussed above), for example by setting the origin of the standardized 3D coordinate system at the centroid of the segmentation (the centroid is an arithmetic mean of all vertices (pϵR³) of the mesh), and setting the orientation of the 3D coordinate axes defined by the axial, coronal and sagittal planes of the organ or region of interest (e.g., identified via principal component analysis of the mesh).

Optionally the DPC may preprocess one or more 2D acoustic images, for example by cropping the 2D acoustic image to a relevant rectangular region of interest.

The DPC may also compute the actual pose Ti of each (potentially pre-processed) 2D acoustic image relative to the standardized 3D coordinate system using the equation:

Tᵢ=T_{3DUS_to_standardized}*T_{tracking_to_3DUS}*T_{2DUS_to_tracking},

where T_{2DUS_to_tracking} is the pose of the (potentially cropped) acoustic image in tracking space, T_{tracking_to_3DUS} is the pose of the 3D acoustic image in the tracking space, and T_{3DUS_to_standardized} is the pose of the 3D acoustic image in the standardized space (segmentation-based) 3D coordinate system, as described above and in FIG. 5.

At the end of these operations, a large set of 2-tuples dᵢ may be provided:

dᵢ=(Sᵢ, Tᵢ),

where Sᵢ is an input ultrasound image and Tᵢ is a rigid transformation describing the position and orientation (herein referred to as the “actual pose”) of the ultrasound image Sᵢ in the standardized 3D coordinate system. The DPC provides this set of 2-tuples dᵢ to a network training controller (NTC).

The NTC is configured to: receive the set of 2-tuples from the DPC, and batch-wise train the CNN using sets of the provided 2-tuples that is to optimize parameters/weights of the CNN to minimize differences between the predicted poses of the 2D acoustic images, which are output by the CNN, and the actual poses for all of the spatially tracked 2D acoustic images for all of the subjects, which are obtained as described above. The NTC may comprise a processing system such as processing system 30 described above.

Thus, the output of the training framework may be an optimized set of parameters/weights for the CNN which maximizes the accuracy with which the CNN predicts unknown poses of 2D acoustic images which are input to it.

Some embodiments of the application framework utilize: an acoustic imaging system (e.g., acoustic imaging system 200); a pose prediction controller (PPC); and a multi-modality imaging controller (MMIC). In some embodiments, the PPC and/or the MMIC may comprise a processing system such as processing system 30 described above.

In some embodiments, the acoustic imaging system may include the PPC and/or the multi-modality imaging controller as part of a processing system (e.g., processing system 212) of the acoustic imaging system.

The acoustic imaging system preferably acquires a sequence of 2D acoustic images of a region of interest, which may include an organ of interest, in the human body. The acoustic imaging system employs an acoustic probe, which in some embodiments may be a hand-held transrectal ultrasound (TRUS) or transthoracic echocardiography (TTE) transducer. Whatever acoustic probe is employed, it does not include and is not associated with any tracking device, such as an IMU, EM tracker, optical tracker, etc. In other words, the acoustic imaging system does not acquire any tracking, location, orientation, or pose information for the acoustic probe as the acoustic probe is used to gather acoustic image data for the 2D acoustic images.

The PPC includes a deep neural network, for example a convolutional neural network (CNN) consisting of single or plurality of intermediate layers and last regression layers, for example as illustrated in FIG. 6. The number of intermediate convolutional layers may depend on the complexity of the region or organ of interest. Each convolutional layer may consist of a convolution, non-linear regularization, batch normalization and spatial pooling. The neural network may be trained using the aforementioned training dataset—processed by the TDC—on the task to predict a rigid transformation in the standardized 3D coordinate system for a given current 2D acoustic image for which no position, orientation, pose or tracking information is available. Rigid transformation can be separated into translational and rotational components as specified by the last layer.

The PPC is configured to provide the CNN with an input 2D acoustic image, and to obtain from the CNN as an output the predicted pose of the 2D acoustic image in the standardized coordinate system.

A volume reconstruction controller (VRC) is configured to reconstruct a 3D acoustic image of the ROI or a reference structure (e.g., an organ) in the ROI from the sequence of 2D acoustic images and their poses predicted by the convolutional neural network, using methods known in the art as described above.

Some embodiments of the application framework include an intraoperative acoustic imaging modality, the VRC and a display such as display device 216.

The intraoperative acoustic imaging modality may include a 2D acoustic probe as described above and may acquire a sequence or sweep of 2D acoustic images of an ROI in real time, without spatial tracking, and send the 2D acoustic images to the VRC.

The VRC may receive the 2D acoustic images and provide them to a trained convolutional neural network (CNN) which predicts a rigid transformation that describes the pose (position and orientation) of each 2D acoustic image with respect to a standardized 3D coordinate system. The VRC may use the 2D acoustic images and their corresponding poses, provided by the trained CNN, to reconstruct a 3D acoustic image of the ROI using a volume compounding controller (VCC) using methods known in the art, as described above. The VRC and the VCC may comprise a processing system such as processing system 30 described above.

The display device 216 may display the 3D volumetric acoustic image to a user, for example in conjunction with an acoustic imaging system such as acoustic imaging system 200, and, for example: visualize and verify the reconstruction; perform volumetric measurements; plan a procedure; register the 3D acoustic image with 3D images obtained using other imaging modalities (e.g., CT or MRI) for improved diagnosis or guidance of therapy; display in real-time positioning of the 2D acoustic images on the reconstructed 3D acoustic image; and/or provide feedback to the user regarding the 2D acoustic images relative to a standardized coordinate system shown within the reconstructed 3D acoustic image volume.

FIG. 8 depicts an example of localization of a sequence of un-tracked 2D acoustic images based on the predictions of a trained convolutional neural network.

An image 810 on the left hand side of FIG. 8 shows the localization of a sequence of tracked two dimensional ultrasound images 812 in a three dimensional tracking space using an electromagnetic tracking system.

For comparison, an image 820 on the right hand side of FIG. 8 shows the corresponding localization of the same sequence of two dimensional ultrasound images 822 obtained without use of the electromagnetic tracking information, i.e. solely based on the frame positions predicted by the trained CNN. The pose predictions are in a standardized three dimensional coordinate system, which is based on a segmentation of a region of interest (ROI) or reference structure in the ROI. Here, the acoustic imaging user performed an angled sweep across the region, or reference structure, of interest during the acquisition, covering a cone-shaped region of interest, which is visible in the CNN-predicted, angled poses of the individual two dimensional acoustic images. The solid lines 812A and 822A highlight the first frame in the sequence, and the solid lines 812B and 822B highlight the rectangular ROI within the image frame that was used for the pose prediction. The “squiggly” lines 812C and 822C show the predicted trajectory of the upper left corner of the two dimensional acoustic image throughout the image acquisition sequence, and the dashed lines 812D and 822D show the predicted trajectory of the upper left corner of the ROI throughout the image acquisition sequence.

FIG. 8 illustrates the good match of the relative frame positions and orientations between the two methods, showing the same cone-shaped region covered by the ultrasound sweep. The global translation and rotation between the two visualizations is irrelevant for tracking purposes, and is due to the arbitrary choice of the electromagnetic tracking and standardized coordinate systems.

The pose predictions for the sequence of two dimensional acoustic images may be used to construct a three dimensional acoustic image of a volume in the region of interest, which can be used, e.g., to: perform volumetric measurements; and/or to create extended three dimensional acoustic imaging fields of view to show entire organs or other structures which are too large to be captured in a single two dimensional or three dimensional acoustic image.

FIG. 9 illustrates a flowchart 900 of an example embodiment of a method of training a convolutional neural network to provide accurate estimates of the poses of two dimensional acoustic images in a three dimensional reference coordinate system using series of spatially tracked two dimensional acoustic images obtained from a plurality of subjects, i.e., a plurality of acoustic images of a region of interest (ROI), at a plurality of different poses, obtained from each of a plurality of different subjects. The method of FIG. 9 involves obtaining a series of spatially tracked two dimensional acoustic images (e.g., 20 images) of the ROI in each of a plurality of different subjects (e.g., 20 subjects) in order to train the system. Here a subject is a creature living or dead, for example a human being. The identities of the subjects are irrelevant to this method, and the subjects can be located or chosen in any convenient way (volunteers, employees, people for whom acoustic images of the ROI are being taken in the course of diagnosis or treatment, etc.).

An operation 905 includes defining a standardized three dimensional coordinate system for a region of interest (ROI) in a subject's body. The ROI may include a reference structure having a known shape and orientation in the body, for example an organ, a bone, a joint, one or more blood vessels, etc. In some embodiments, the standardized three dimensional coordinate system for the ROI may be defined by selecting an origin and three mutually orthogonal axes for the standardized three dimensional coordinate system based on a priori knowledge about an abstract reference structure (e.g., an abstract organ, such as a liver) in the ROI. Operation 910 may be performed using methods described above with regards to FIG. 5. For example, as explained above with FIG. 5, in some embodiments the standardized three dimensional coordinate system may be selected using the axial, sagittal, and coronal planes for an abstract reference structure, such as an organ.

An operation 910 includes selecting a first subject for the subsequent operations 915 through 940.-Here the first subject may be selected in any convenient way, for example randomly, as the order in which subjects are selected is irrelevant to the method of FIG. 9.

An operation 915 includes obtaining a series of spatially tracked two dimensional acoustic images of the ROI in the subject using a tracking device, such as an EM or optical tracker.

An operation 920 includes constructing a three dimensional acoustic image of the ROI in the subject from the series of spatially tracked two dimensional acoustic images of the ROI, wherein the three dimensional acoustic image of the ROI in the subject is in an acoustic three dimensional coordinate system.

An operation 925 includes segmenting a reference structure in the three dimensional volumetric image of the ROI in the subject. The reference structure having a known shape and orientation in the body, and may be, for example an organ, a bone, a joint, one or more blood vessels, etc.

An operation 930 includes defining an acoustic image three dimensional coordinate system from the three dimensional volumetric acoustic image of the ROI in the subject, based on the segmentation of the acoustic images of the actual reference structure (e.g., an actual organ) in the subject in operation 925.

An operation 935 includes determining, for each of the spatially tracked two dimensional acoustic images (obtained in operation 915) of the ROI in the subject its actual pose in the standardized three dimensional coordinate system (defined in operation 905) using: a pose of the spatially tracked two dimensional acoustic image in the acoustic image three dimensional coordinate system (defined in operation 930) corresponding to the spatially tracked two dimensional acoustic image, and a coordinate system transformation from the corresponding acoustic image three dimensional coordinate system to the standardized three dimensional coordinate system.

An operation 940 includes determining whether the current subject is the last subject. If the current subject is not the last subject, then the process returns to operation 915, and operations 915 through 940 are performed for the next subject. If the current subject is the last subject, then the process proceeds to operation 945. An operation 945 includes performing an optimization process on a convolutional neural network (CNN) by providing the spatially tracked two dimensional acoustic images to the CNN and adjusting parameters of the CNN to minimize differences between predicted poses generated by the CNN for the spatially tracked two dimensional acoustic images and the actual poses of the spatially tracked two dimensional acoustic images. Beneficially, operation 945 may be performed “batch-wise,” i.e. by sequentially taking random subsets (e.g. 16, or 32) of the groups of images across a plurality of subjects and feeding them as inputs to the CNN for the next optimization step. For example, if 20 spatially tracked two dimensional acoustic images were obtained in operation 915 for each of 20 different subjects, that would produce a total of 400 spatially tracked two dimensional acoustic images, and each batch might be only, e.g., 16 or 32 of those 400 spatially tracked two dimensional acoustic images. During the training process, parameters of the CNN may be constantly updated by propagating errors between predicted and ground truth values for the poses given an input image that is fed to the CNN.

FIG. 10 illustrates a flowchart 1000 of an example embodiment of a method of processing a sequence of 2D acoustic images of a region of interest (ROI) in a subject, obtained without spatial tracking, to produce a 3D volumetric acoustic image of the ROI.

An operation 1010 includes employing an acoustic probe to acquire a series of two dimensional acoustic images of a region of interest (ROI) in a subject without spatial tracking of the acoustic probe.

An operation 1020 includes applying the two dimensional acoustic images to a convolutional neural network which has been trained using a plurality of previously-obtained two dimensional acoustic images of corresponding ROIs in a plurality of other subjects which were obtained with spatial tracking.

An operation 1030 includes the convolutional neural network predicting a pose for each of the two dimensional acoustic images of the ROI in the subject with respect to a standardized three dimensional coordinate system.

An operation 1040 includes using the predicted pose for each of the two dimensional acoustic images of the ROI in the subject with respect to the standardized three dimensional coordinate system to produce a three dimensional acoustic image of the ROI in the subject from the series of two dimensional acoustic images of the ROI of the subject.

While preferred embodiments are disclosed in detail herein, many variations are possible which remain within the concept and scope of the invention. Features and elements from various embodiments described herein can be combined to produce other embodiments within the scope of the invention. Such variations would become clear to one of ordinary skill in the art after inspection of the specification, drawings and claims herein. The invention therefore is not to be restricted except within the scope of the appended claims.

1. A system, comprising:
an acoustic probe, the acoustic probe having an array of acoustic transducer elements,
wherein the acoustic probe is not associated with any tracking device,
wherein the acoustic probe is configured to transmit one or more acoustic signals to a region of interest (ROI) in a subject, and
wherein the acoustic probe is configured to receive acoustic echoes from the region of interest; and
an acoustic imaging instrument; connected connected to the acoustic probe, the acoustic imaging instrument comprising:
a communication interface the communication interface configured to provide transmit signals to at least some of the acoustic transducer elements,
wherein the communication interface is configured to cause the array of acoustic transducer elements to transmit the one or more acoustic signals to the ROI in the subject, and
wherein the communication interface is configured to receive one or more image signals from the acoustic probe produced from the acoustic echoes from the region of interest; and
a processing system, the processing system comprising a memory, wherein the processing system is configured to:
acquire a series of two dimensional acoustic images of the ROI in the subject from the image signals received from the acoustic probe without spatial tracking of the acoustic probe;
predict a pose for each of the two dimensional acoustic images of the ROI in the subject with respect to a standardized three dimensional coordinate system, wherein the predicted pose is based on a plurality of previously-obtained two dimensional acoustic images of corresponding ROIs in a plurality of other subjects which were obtained with spatial tracking; and
use the predicted pose for each of the two dimensional acoustic images of the ROI in the subject with respect to the standardized three dimensional coordinate system to produce a three dimensional acoustic image of the ROI in the subject from the series of two dimensional acoustic images of the ROI of the subject,
wherein the standardized three dimensional coordinate system is defined based on the segmentation of a reference structure in three-dimensional acoustic images.

2. The system of claim 1, further comprising a display device, wherein the system is configured to display on the display device a representation of the three dimensional acoustic image of the ROI in the subject.

3. The system of claim 1, further comprising a display device, wherein the system is configured to use the predicted poses to display on the display device a plurality of the two dimensional acoustic images relative to each other in the ROI.

4. The system of claim 1, further comprising a display device, wherein the processing system is configured to:
access a three dimensional reference image obtained using a different imaging modality than acoustic imaging;
register the three dimensional acoustic image to the three dimensional reference image; and
display on the display device the three dimensional acoustic image and the three dimensional reference image, registered with each other.

5. The system of claim 4, wherein the system is configured to superimpose the three dimensional acoustic image and the three dimensional reference image with each other on the display device.

6. The system of claim 1, further comprising a display device,
wherein the subject includes a reference structure,
wherein the system is configured to segment the reference structure in the three dimensional acoustic image of the ROI of the subject,
wherein the system is configured to register the segmented reference structure to a generic statistical model of the reference structure,
wherein the system is configured display on the display device at least one of the two dimensional images of the ROI in the subject relative to the generic statistical model of the reference structure.

7. The system of claim 1, further comprising a display device,
wherein the system is further configured to generate one or more cut-plane views from the three dimensional acoustic image with is not coplanar with any of the two dimensional images of the ROI in the subject,
wherein the system is further configured to display on the display device the one or more cut-plane views.

8. A method, comprising:
employing an acoustic probe to acquire a series of two dimensional acoustic images of a region of interest (ROI) in a subject without spatial tracking of the acoustic probe;
predicting a pose for each of the two dimensional acoustic images of the ROI in the subject with respect to a standardized three dimensional coordinate system based on a plurality of previously-obtained two dimensional acoustic images of corresponding ROIs in a plurality of other subjects which were obtained with spatial tracking; and
generating a three dimensional acoustic image of the ROI in the subject from the series of two dimensional acoustic images of the ROI of the subject using the predicted pose for each of the two dimensional acoustic images of the ROI,
wherein the standardized three dimensional coordinate system is defined based on the segmentation of a reference structure in three-dimensional acoustic images.

9. The method of claim 8, further comprising displaying on a display device a representation of the three dimensional acoustic image of the ROI in the subject.

10. The method of claim 8, further comprising using the predicted poses to display on a display device a plurality of the two dimensional acoustic images relative to each other in the ROI.

11. The method of claim 8, further comprising:
accessing a three dimensional reference image obtained using a different imaging modality than acoustic imaging;
registering the three dimensional acoustic image to the three dimensional reference image; and
displaying on a display device the three dimensional acoustic image and the three dimensional reference image, registered with each other.

12. The method of claim 11, further comprising superimposing the three dimensional acoustic image and the three dimensional reference image with each other on the display device.

13. The method of claim 8, wherein the ROI in the subject includes a reference structure, and wherein the method further comprises:
segmenting the reference structure in the three dimensional acoustic image of the ROI of the subject;
registering the segmented reference structure to a generic statistical model of the reference structure; and
displaying on a display device at least one of the two dimensional images of the ROI in the subject relative to the generic statistical model of the reference structure.

14. The method of claim 8, further comprising:
generating one or more cut-plane views from the three dimensional acoustic image which is not coplanar with any of the two dimensional images of the ROI in the subject, and
displaying on a display device the one or more cut-plane views.

15. A method, comprising:
obtaining a plurality of series of spatially tracked two dimensional acoustic images of a region of interest (ROI) in a corresponding plurality of subjects;
for each series of spatially tracked two dimensional acoustic images, constructing a three dimensional volumetric acoustic image of the ROI in the corresponding subject;
for each series of spatially tracked two dimensional acoustic images, segmenting a reference structure within each of the three dimensional volumetric acoustic images of the ROI;
for each series of spatially tracked two dimensional acoustic images, defining a corresponding acoustic image three dimensional coordinate system for each of the three dimensional volumetric acoustic images, based on the segmentation;
for each series of spatially tracked two dimensional acoustic images, defining a standardized three dimensional coordinate system for the ROI based on the segmentation of a reference structure in three-dimensional acoustic images;
determining, for each of the spatially tracked two dimensional acoustic images of the ROI in the plurality of series of spatially tracked two dimensional acoustic images, its actual pose in the standardized three dimensional coordinate system, using a pose of the spatially tracked two dimensional acoustic image in the acoustic image three dimensional coordinate system corresponding to the spatially tracked two dimensional acoustic image, and a coordinate system transformation from the corresponding acoustic image three dimensional coordinate system to the standardized three dimensional coordinate system;
providing, to a convolutional neural network, the spatially tracked two dimensional acoustic images of the ROI from the plurality of series, wherein the convolutional neural network generates a predicted pose in the standardized three dimensional coordinate system for each of the provided spatially tracked two dimensional acoustic images; and
performing an optimization process on the convolutional neural network to minimize differences between the predicted poses and the actual poses for all of the provided spatially tracked two dimensional acoustic images.

16. The method of claim 15,
wherein the reference structure is an organ, and
wherein segmenting the reference structure in each of the three dimensional volumetric acoustic images of the ROI comprises segmenting the organ in the three dimensional volumetric acoustic image.

17. The method of claim 16, wherein defining the standardized three dimensional coordinate system for the ROI comprises:
defining an origin for the standardized three dimensional coordinate system at a centroid of the segmented organ; and
defining three mutually orthogonal axes of the standardized three dimensional coordinate system to be aligned with axial, coronal, and sagittal planes of the organ.

18. The method of claim 15, wherein defining the standardized three dimensional coordinate system for the ROI comprises selecting an origin and three mutually orthogonal axes for the standardized three dimensional coordinate system based on a priori knowledge about the reference structure.

19. The method of claim 15, wherein the provided spatially tracked two dimensional acoustic images are randomly selected from the plurality of series of spatially tracked two dimensional acoustic images of the ROI in the corresponding plurality of subjects.

20. The method of claim 15, wherein obtaining the series of spatially tracked two dimensional acoustic images of the ROI in the subject comprises receiving one or more imaging signals from an acoustic probe in conjunction with receiving an inertial measurement signal from an inertial measurement unit which spatially tracks movement of the acoustic probe while it provides the one or more imaging signals.
